(19) United States
(12) Patent Application Publication
(10) Pub. No.: US 2020/0299850 A1
(43) Pub. Date: Sep. 24, 2020

(54) PROCESSES FOR TREATING ELECTROLYTE FROM AN ELECTROREFINING PROCESS

(71) Applicant: ECO-TEC LIMITED, Pickering (CA)

(72) Inventors: Katerina KRYST, Whitby (CA); Michael SHEEDY, Uxbridge (CA)

(21) Appl. No.: 16/362,055

(22) Filed: Mar. 22, 2019

(51) Int. Cl. C25C 7/06; B01J 47/02; C25C 1/12; B01D 15/36

(52) U.S. Cl. CPC C25C 7/06; B01D 15/361; C25C 1/12; B01J 47/02

(57) ABSTRACT

There is provided a process for treating an aqueous solution including impurity material disposed in a first state, comprising:, comprising: modifying the state of the impurity material, disposed in its first state, with effect that a second state of the impurity material is obtained, such that a conditioned aqueous solution, including the modified impurity material, is obtained. The conditioned aqueous solution is contacted with an operative sorptive media with effect that at least a portion of the modified impurity material becomes sorbed to the operative sorptive media, such that an impurity material-depleted aqueous solution is produced.

### FIELD

The present disclosure relates to electrorefining of copper and processes for preventing accumulation of impurities within the electrolyte.

### BACKGROUND

During the electrorefining of metals, impurities may accumulate within the electrolyte. The accumulation of such impurities may interfere with the electrorefining. Additionally, such accumulation may result in impurities being present in sufficiently high concentrations that it becomes unsafe to handle the electrolyte.

### SUMMARY

In one aspect, there is provided a process for treating an aqueous solution including an impurity material in its first state, comprising: modifying the state of an impurity material, disposed in its first state, with effect that a second state of the impurity material is obtained, such that a conditioned aqueous solution, including the modified impurity material, is obtained; and contacting the conditioned aqueous solution with an operative sorptive media with effect that at least a portion of the modified impurity material becomes sorbed to the operative sorptive media, such that an impurity material-depleted aqueous solution is produced. In some embodiments, for example, modifying the state of the impurity material renders the impurity material more conducive to separation by sorptive media.

In another aspect, there is provided a process for treating a feed material with a reagent, comprising; emplacing a reaction zone discharge in selective mass transfer communication with the feed material such that reagent material is transferred from the reaction zone discharge to the feed material, with effect that a modified feed material is obtained that is augmented with the transferred reagent material; contacting the modified feed material with an adscititious reagent material within a reaction zone, such that a reactive process is effected to produce a reaction product, and such that a reaction zone material becomes disposed in the reaction zone and includes the reaction product and residual reagent material; and discharging the reaction zone material from the reaction zone; wherein the discharged reaction zone material defined the reaction zone discharge.

### BRIEF DESCRIPTION OF DRAWINGS

The preferred embodiments will now be described with reference to the following accompanying drawings, in which:

FIG. 1 is process flow diagram of an embodiment of a process of the present disclosure.

### DETAILED DESCRIPTION

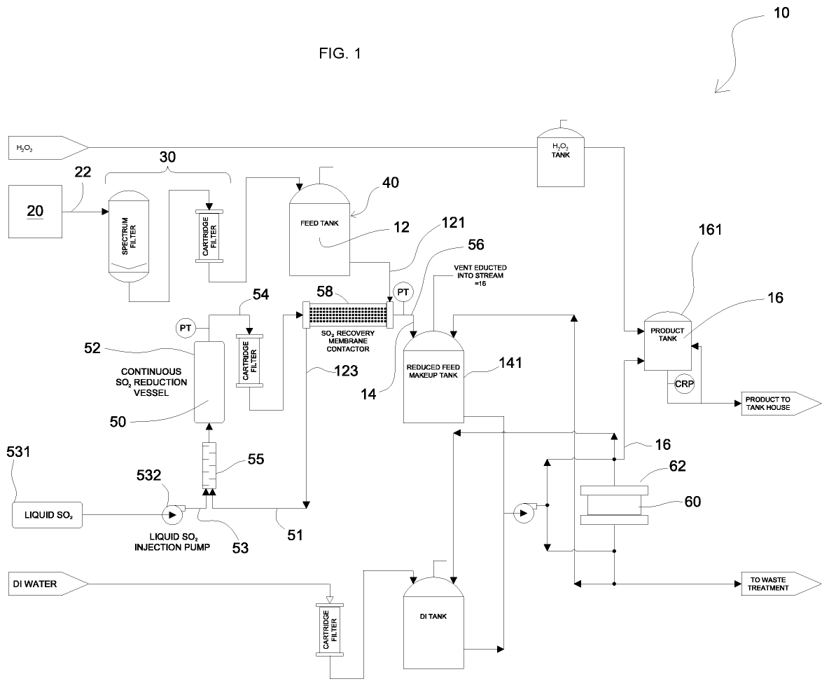

Referring to FIG. 1, there is provided a system 10 for treating an aqueous solution comprising an impurity material. The treating is with effect that at least a portion of the impurity material is separated from the aqueous solution, such that an impurity material-depleted aqueous solution is obtained 16.

In some embodiments, for example, the aqueous solution 12 includes an electrolyte. In some embodiments, for example, the electrolyte is derived from an electrolysis process. In some embodiments, for example, the electrolysis process is a process for effecting electrodeposition of a target metal. In some embodiments, for example, the electrolysis process is a process for effecting electrorefining of a target metal. In some embodiments, for example, the electrolyte is process electrolyte from an electrolysis cell 20 within which the electrolysis process is being effected, wherein the process electrolyte is for effecting electrical communication between an anode and a cathode. In some embodiments, for example, the electrolyte is a bleed 22 of the process electrolyte. In some embodiments, for example, the bleed 22 is treated with a mechanical filter in a unit operation 30 for removing solid particulate matter, and then supplied to a feed tank 40 for maintaining a suitable inventory of the aqueous solution 12 for continuously supplying the process.

In some embodiments, for example, the electrolysis process is a continuous process, and while the electrolysis process is being effectuated, an electrolyte bleed is being obtained from the process electrolyte, treated via the process described herein to produce the impurity material-depleted aqueous solution, and the impurity material-depleted aqueous solution is supplied to the electrolysis cell.

In some embodiments, for example, the process electrolyte includes dissolved target material which has not been deposited on the cathode, and, in this respect, the aqueous solution includes the target material.

In some embodiments, for example, the target metal is copper.

In those embodiments where the process is for effecting electrorefining of copper, the electrorefining is effected via an electrolysis cell connected to an electrical voltage and/or current source. The electrolysis cell includes an anode, a cathode, and the process electrolyte. The process electrolyte is provided for effecting electrical communication between the anode and the cathode.

The anode includes anode grade copper. The anode grade copper includes one or more impurities. Exemplary impurities include arsenic, silver, gold, bismuth, iron, nickel, diatomic oxygen, platinum, sulphur, antimony, selenium, tellurium, and zinc.

During the electrorefining of copper, higher purity copper (relative to the purity of copper of the anode) is electroplated onto the cathode, and impurities within the anode grade copper are liberated and soluble species become dissolved within the process electrolyte. To prevent accumulation of one or more of these impurities within the process electrolyte, a bleed is obtained from the process electrolyte and treated as described herein to produce the impurity material-depleted aqueous solution.

In some embodiments, for example, the process electrolyte includes sulphuric acid. In some embodiments, for example, the concentration of sulphuric acid within the process electrolyte is from 50 grams per litre to 350 grams per litre, such as, for example, from 150 grams per litre to 225 grams per litre.

In some embodiments, for example, the impurity material is a metal or a metalloid. In some embodiments, for example, the impurity material includes both of a metal and a metalloid. In some embodiments, for example, the impurity material is arsenic. In some embodiments, for example, the concentration of arsenic within the aqueous solution is from three (3) grams per litre to 16 grams per litre, such as, for example, from five (5) grams per litre to 15 grams per litre.

The impurity material is configurable in at least a first state and a second state. The aqueous solution includes the impurity material disposed in the first state. In some embodiments, the aqueous solution also includes quantities of the impurity material in the second state. The treating of the aqueous solution includes modifying the state of an impurity material, disposed in its first state, within a zone 50, from the first state to a second state, with effect that the impurity material becomes disposed in the second state, such that a modified impurity material is produced. In other words, the state of the impurity material is modified from the first state to the second state. In this respect, the treating produces a conditioned aqueous solution 14, and the produced conditioned aqueous material includes the modified impurity material.

After the conditioned aqueous solution 14 has been obtained, at least a portion of the modified impurity material is separated from the conditioned aqueous solution via a sorption process. In this respect, the treating further includes contacting the conditioned aqueous solution with an operative sorptive media within a zone 60, with effect that at least a portion of the modified impurity material becomes sorbed to the operative sorptive media, such that the obtaining of the impurity material-depleted aqueous solution 16 is effected.

In this respect, and returning to the modifying of the state of the impurity material, in some embodiments, for example, the modifying of the state of the impurity material is with effect that affinity of the impurity material to the operative sorptive media is decreased. In this respect, the affinity of the first state of the impurity material to the operative sorptive media is greater than the affinity of the second state of the impurity material to the operative sorptive media. Also in this respect, the impurity material and the operative sorptive media are co-operatively configured such that, the first state of the impurity material is sorbable to the operative sorptive media to define a first sorbed configuration and the second state of the impurity material is sorbable to the operative sorptive media to define a second sorbed configuration, and desorbing of the impurity material from the second sorbed configuration is thermodynamically favourable relative to the desorbing of the impurity material from the first sorbed configuration.

In some embodiments, for example, the modifying of the state of the impurity material includes a change to the oxidation state of the impurity material. In those embodiments where the impurity material is arsenic (V), in some of these embodiments, for example, the modification is from arsenic (V) to arsenic (III).

In some embodiments, for example, the modifying of the state of the impurity material is effected by a reduction of the impurity material. In this respect, in some embodiments, for example, the modifying of the state of the impurity material includes contacting the aqueous material with a reducing agent within zone 50, such that zone 50 is a reaction zone 50. In some embodiments, for example, the ratio of moles of reducing agent to moles of impurity material, disposed in the first state, is at least 1:1, such as, for example, at least 2:1, such as, for example, at least 5:1. In some embodiments, for example, the reaction zone 50 is disposed within a reaction vessel 52.

In some embodiments, for example, the contacting of the aqueous material with the reducing agent within the reaction zone 50 includes supplying the aqueous material and the reducing agent to the reaction zone 50 such that a reaction zone material becomes disposed within the reaction zone 50, and while the supplying is being effected, discharging the reaction zone material from the reaction zone with effect that a reaction zone discharge 54 is produced and includes the modified impurity material. The residence time of the reaction zone material within the reaction zone 50 is at least 15 minutes, such as, for example, from 15 minutes to 150 minutes, such as, for example, from 30 minutes to 120 minutes, such as, for example, from 50 minutes to 90 minutes, such as, for example, 70 minutes. The modified impurity material, of the conditioned aqueous material 14, is derived from the reaction zone discharge 54. In this respect, the conditioned aqueous material 14 includes at least a portion of (and, in some embodiments, for example, is defined by) the reaction zone discharge 54.

In some embodiments, for example, the supplying of the impurity material and the reducing agent is effected via supplying of an impurity material-comprising feed 51 and a reducing agent supply 53.

In this respect, the impurity material-comprising feed 51 is supplied to the reaction zone 50, and the impurity material-comprising feed includes impurity material (disposed in at least its first state) derived from the aqueous material 12. In this respect, the impurity material-comprising feed 51 includes at least a portion of the aqueous solution 12 being treated by the subject process.

Also in this respect, the reducing agent supply 53 is supplied to the reaction zone from a reducing agent supply source 531, such that at least a portion of the reducing agent, disposed within the reaction zone 50, is supplied from the reducing agent supply source 531.

In some embodiments, for example, prior to being supplied to the reaction zone 50, the impurity material-comprising feed 51 is admixed with the reducing agent supply 53 within a static mixer 55.

In some embodiments, for example, at least another portion of the reducing agent, supplied to the reaction zone 50, is unreacted reducing agent that has been recycled from the reaction zone discharge 54. In this respect, in some embodiments, for example, the reaction zone discharge 54 also includes residual reducing agent (i.e. unreacted reducing agent), and the reaction zone discharge 54 becomes disposed in selective mass transfer communication with an aqueous solution feed 121, including the aqueous solution 12, with effect that at least a portion of the residual reducing agent is transferred from the reaction zone discharge 54 to the aqueous solution feed 121, such that the reaction zone discharge 54 is converted to a modified reaction zone discharge 56, depleted in the residual reducing agent that is transferred to the aqueous solution feed 121, and the aqueous solution feed 121 is converted to a modified aqueous solution feed 123, augmented with the transferred residual reducing agent. The conditioned aqueous solution 14 derives the modified impurity material from the modified reaction zone discharge 56, such that the conditioned aqueous solution includes at least a portion of (and, in some embodiments, for example, is defined by) the modified reaction zone discharge 56. The impurity material-comprising feed 51 derives the impurity material and the transferred residual reducing agent from the modified aqueous solution feed 123, such that the impurity material-comprising feed includes at least a portion of (and, in some embodiments, for example, is defined by) the modified aqueous solution feed 123.

The transferring of the at least a portion of the residual reducing agent, from the reaction zone discharge to the aqueous solution feed, mitigates underutilization of the reducing agent that is supplied from the reducing agent source 531, and also mitigates any detrimental effects of such residual reducing agent on downstream processes. In some embodiments, for example, the transferring of the at least a portion of the residual reducing agent is effected via a membrane contactor 58. In some embodiments, for example, the membrane contactor includes a 3M™ Liqui-Cel™ EXF-8x80 Series Membrane Contactor.

In some embodiments, for example, prior to supplying the reaction zone discharge 54 to the membrane contactor 58, solid material is separated from the reaction zone discharge 54. In some embodiments, for example, undesirable solids may be produced within the reaction zone 50, and these may be discharged from the reaction zone 50 as part of the reaction zone discharge 54.

In those embodiments where the impurity material is arsenic, in some of these embodiments, for example, the reducing agent includes sulphur dioxide. In some of these embodiments, for example, the sulphur dioxide is disposed in an aqueous state. In some embodiments, for example, the sulphur dioxide, is sufficiently pressurized such that the sulphur dioxide remains disposed in the aqueous state within the membrane contactor. In this respect, in some embodiments, for example, the sulphur dioxide, being supplied to the reaction zone 50 from the reducing agent source 531, is sufficiently pressurized by a suitable pump 532. Also, in some embodiments, for example, the sulphur dioxide, of the residual reducing agent within the reaction zone discharge 54, being supplied to the membrane contactor 58, is pressurized by a booster pump for maintaining the sulphur dioxide in the aqueous state. It is understood that, in some embodiments, at least a portion of the aqueous state of sulphur dioxide includes sulphurous acid (H₂SO₃).

As discussed above, after the conditioned aqueous solution 14 has been obtained, the treating further includes contacting the conditioned aqueous solution with an operative sorptive media within the zone 60 with effect that at least a portion of the modified impurity material becomes sorbed to the operative sorptive media such that the obtaining of the impurity material-depleted aqueous solution is effected. In some embodiments, for example, prior to the contacting of the conditioned aqueous solution with an operative sorptive media, the conditioned aqueous solution 14 is supplied to a storage tank 141 for maintaining an inventory of conditioned aqueous solution for the contacting with the operative sorptive media.

In some embodiments, for example, the sorption of the modified impurity material to the operative sorptive media is effected in response to an exchange of material between the modified impurity material of the aqueous solution and an exchangeable material of the operative sorptive media.

In some embodiments, for example, the exchange of material includes an exchange of ions. In this respect, in some embodiments, for example, the operative sorptive media includes ion exchange material, such as, for example, ion exchange resin. In those embodiments where the modified impurity material is arsenic (III), in some of these embodiments, for example, the exchange of material includes an exchange of cations, and, in this respect, the operative sorptive media includes a chelating resin, such as, for example, a polymeric resin with a polyhydroxy amine functional group.

In some embodiments, for example, the ion exchange material is disposed within the zone 60, such that the zone 60 is a contacting zone 60. In some embodiments, for example, the contacting zone is defined within a vessel 62. In some embodiments, for example, the contacting of the conditioned aqueous solution with an operative sorptive media includes supplying the conditioned aqueous material to the contacting zone 60 such that a contacting zone material becomes disposed within the contacting zone 60, and while the supplying is being effected, discharging the contacting zone material from the contacting zone 60 with effect that a contacting zone discharge is produced and defines the impurity material-depleted aqueous solution 16. The residence time of the contacting zone material within the contacting zone 60 is at least three (3) seconds. In some embodiments, for example, the volume of operative sorptive media is at least 70 millilitres, such as, for example, at least 250 millilitres, such as, for example, at least 500 millilitres, such as, for example, at least 1000 millilitres.

In some embodiments, for example, after sufficient loading of the operative sorptive media in response to, over time, the contacting of the conditioned aqueous material with the operative sorptive media, the contacting is suspended. After the suspending, the loaded operative sorptive media is regenerated in response to contacting the loaded operative sorptive media with a regenerant solution. In this respect, the sorbed impurity material becomes desorbed in response to the contacting with the regenerant solution, with effect that the operative sorptive media is regenerated.

In some embodiments, for example, the produced impurity material-depleted aqueous solution is conducted to a product storage vessel 161 for maintaining of inventory of the impurity material-depleted aqueous solution for supply to the electrolysis process, and thereby maintaining sufficient electrolyte within the electrolysis cell, while mitigating the continued accumulation of an undesirable quantity of the impurity material within the electrolysis cell 20.

In those embodiments where the reducing agent includes sulphur dioxide, in some of these embodiments, residual sulphur dioxide remains within the produced impurity material-depleted aqueous solution. In such embodiments, hydrogen peroxide is contacted with the produced impurity material-depleted aqueous solution, with effect that the sulphur dioxide is converted to sulphuric acid, which is already a component of the impurity material-depleted aqueous solution. In this respect, by effecting this conversion, the introduction of alien material to the electrolysis process is mitigated.

In the above description, for purposes of explanation, numerous details are set forth in order to provide a thorough understanding of the present disclosure. However, it will be apparent to one skilled in the art that these specific details are not required in order to practice the present disclosure. Although certain dimensions and materials are described for implementing the disclosed example embodiments, other suitable dimensions and/or materials may be used within the scope of this disclosure. All such modifications and variations, including all suitable current and future changes in technology, are believed to be within the sphere and scope of the present disclosure. All references mentioned are hereby incorporated by reference in their entirety.

1.-36. (canceled)

37. A process for treating an aqueous solution including impurity material disposed in a first state, comprising:
modifying the state of the impurity material, disposed in the first state, from the first state to the second state, such that a conditioned aqueous solution, including the modified impurity material, is obtained; and
contacting the conditioned aqueous solution with an operative sorptive media with effect that at least a portion of the modified impurity material becomes sorbed to the operative sorptive media, such that an impurity material-depleted aqueous solution is produced.

38. The process as claimed in claim 37;
wherein the modifying of the state of the impurity material is with effect that affinity of the impurity material to the operative sorptive media is decreased.

39. The process as claimed in claim 37;
wherein the modifying of the state of the impurity material includes a change to the oxidation state of the impurity material.

40. The process as claimed in claim 37;
wherein the modifying of the state of the impurity material is effected by a reduction of the first state of the impurity material.

41. The process as claimed in claim 37;
wherein the sorption of the modified impurity material to the operative sorptive media is effected in response to an exchange of material between the modified impurity material of the aqueous solution and an exchangeable material of the operative sorptive media; and
the exchange of material includes an exchange of ions, such that the operative sorptive media includes ion exchange material.

42. The process as claimed in claim 41;
wherein:
the ion exchange material is disposed within a contacting zone; and
the contacting of the conditioned aqueous solution with an operative sorptive media includes supplying the conditioned aqueous material to the contacting zone such that a contacting zone material becomes disposed within the contacting zone, and while the supplying is being effected, discharging the contacting zone material from the contacting zone with effect that the impurity material-depleted aqueous solution is obtained, and the residence time of the contacting zone material within the contacting zone is at least three (3) seconds.

43. The process as claimed in claim 37;
further comprising:
electrorefining a target metal within an electrolysis cell;
bleeding a portion of the electrolyte from the electrolysis cell;
wherein the aqueous solution is defined by the bleed.

44. The process as claimed in claim 43;
further comprising, after the impurity material-depleted aqueous solution has been produced:
supplying the electrolysis cell with the impurity material-depleted aqueous solution.

45. The process as claimed in claim 37;
wherein:
the impurity material is arsenic;
the first state of arsenic is arsenic (V); and
the second state of arsenic is arsenic (III).

46. The process as claimed in claim 45;
wherein the modifying of the impurity material includes contacting the aqueous solution with a reducing agent within a reaction zone.

47. The process as claimed in claim 46;
wherein the reducing agent is sulphur dioxide.

48. The process as claimed in claim 47;
wherein the ratio of moles of sulphur dioxide to the moles of arsenic (V) is at least 1:1.

49. The process as claimed in claim 47;
wherein the contacting of the aqueous material with the reducing agent within the reaction zone includes supplying the aqueous material and the reducing agent to the reaction zone such that a reaction zone material becomes disposed within the reaction zone, and while the supplying is being effected, discharging the reaction zone material from the reaction zone with effect that the conditioned aqueous material is produced, and the residence time of the reaction zone material within the reaction zone is at least 15 minutes.

50. The process as claimed in claim 47;
wherein:
the impurity material-depleted aqueous solution includes sulphur dioxide;
and further comprising, after the impurity material-depleted aqueous solution has been produced:
converting the sulphur dioxide to sulphuric acid.

51. The process as claimed in claim 50;
wherein the aqueous solution includes sulphuric acid.

52. The process as claimed in claim 45;
further comprising:
electrorefining a target metal within an electrolysis cell;
bleeding a portion of the electrolyte from the electrolysis cell;
wherein the aqueous solution is defined by the bleed.

53. The process as claimed in claim 51;
further comprising, after the impurity material-depleted aqueous solution has been produced:
supplying the electrolysis cell with the impurity material-depleted aqueous solution.

54. The process as claimed in claim 51;
wherein the target metal is copper.

55. A process for treating a feed material with a reagent, comprising;
emplacing a reaction zone discharge in selective mass transfer communication with the feed material such that reagent material is transferred from the reaction zone discharge to the feed material, with effect that a modified feed material is obtained that is augmented with the transferred reagent material;
contacting the modified feed material with an adscititious reagent material within a reaction zone, such that a reactive process is effected to produce a reaction product, and such that a reaction zone material becomes disposed in the reaction zone and includes the reaction product and residual reagent material; and
discharging the reaction zone material from the reaction zone;
wherein the discharged reaction zone material defines the reaction zone discharge.

56. The process as claimed in claim 55;
wherein the contacting includes admixing of the modified feed material and the adscititious reagent material.

57. The process as claimed in claim 55;
wherein the adscititious reagent material is supplied to the reaction zone from a reagent material supply source.
